(19) United States
(12) Patent Application Publication
(10) Pub. No.: US 2025/0361733 A1
(43) Pub. Date: Nov. 27, 2025

(54) BIONIC ARCHITECTURE CONSTRUCTION METHOD AND SYSTEM

(71) Applicant: Shenzhen University, Shenzhen (CN)

(72) Inventors: Xiangpeng CAO, Shenzhen (CN); Hongzhi CUI, Shenzhen (CN); Lele CAO, Shenzhen (CN)

(73) Assignee: Shenzhen University, Shenzhen (CN)

(21) Appl. No.: 19/214,080

(22) Filed: May 21, 2025

(30) Foreign Application Priority Data
May 21, 2024 (CN) 202410633310.0

(51) Int. Cl. E04G 21/12; B33Y 10/00; B33Y 30/00; B33Y 50/02; E04G 21/04

(52) U.S. Cl. CPC E04G 21/12; E04G 21/0463; B33Y 10/00; B33Y 30/00; B33Y 50/02; E04G 2021/127

(57) ABSTRACT

A bionic architecture construction method includes: obtaining architecture parameters; analyzing the architecture parameters to obtain filament segment parameters, pillar parameters, and concrete parameters; controlling, based on the pillar parameters, a robotic arm to perform drilling, and inserting a telescopic rod and controlling extension and contraction of the telescopic rod to form a pillar; controlling, based on the filament segment parameters, the robotic arm to extrude filaments between the pillar and a preset ground surface so as to form filament segments, where the filament segments are cooperatively arranged to form a cocoon-like skeleton; pouring concrete into the cocoon-like skeleton based on the concrete parameters to form a cocoon-like shell, where the cocoon-like shell is a closed structure with the filament segments embedded within the concrete; and controlling, based on the architecture parameters, the robotic arm to form a window and a door on the cocoon-like shell to form an architectural shell.

### TECHNICAL FIELD

The present disclosure relates to the technical field of architecture construction, and in particular to a bionic architecture construction method and system.

### BACKGROUND TECHNOLOGY

In order to meet the needs of living, working, and social development, we need to construct architectures in specific locations to meet living and work needs by utilizing technology and resources.

In the prior art, intelligent construction methods such as 3D printing can improve construction efficiency, which mainly include the following steps: 1. Conception and design; 2. Choose appropriate 3D printing technology and materials; 3. Prepare and adjust 3D files; 4. Set printing parameters; 5. Perform print preview and adjustment; 6. Start printing the architecture; 7. Process the printed architecture.

The existing 3D printing in the prior art adopts a planar stacking method, which causes problems. Due to the lack of reinforcing ribs during the printing process, the printed architecture has poor strength, toughness, and durability, and there is still room for improvement.

### CONTENT OF THE INVENTION

To address the problem that the printed architecture has poor strength, toughness, and durability due to the lack of reinforcing ribs during the printing process, the present disclosure provides a bionic architecture construction method and system.

In a first aspect, the present disclosure provides a bionic architecture construction method, which adopts the following technical solutions:

A bionic architecture construction method includes:
obtaining architecture parameters;
analyzing the architecture parameters to obtain filament segment parameters, pillar parameters, and concrete parameters;
controlling, based on the pillar parameters, a robotic arm to perform drilling, and inserting a preset telescopic rod and controlling extension and contraction of the telescopic rod to form a pillar;
controlling, based on the filament segment parameters, the robotic arm to extrude filaments between the pillar and a preset ground surface so as to form filament segments, where the filament segments are cooperatively arranged to form a cocoon-like skeleton;
pouring concrete into the cocoon-like skeleton based on the concrete parameters to form a cocoon-like shell, where the cocoon-like shell is a closed structure with the filament segments embedded within the concrete; and
controlling, based on the architecture parameters, the robotic arm to form a window and a door on the cocoon-like shell to form an architectural shell.

With the above technical solution, an enclosed spatial structure is constructed in a manner similar to silkworm cocooning. This technology can be applied to construction of architectures. Filaments are connected to form reinforcing ribs, and then concrete is poured onto the filaments. The filaments are wrapped in concrete to form a reinforced concrete structure, thereby completing the construction of an architecture and improving the strength and toughness of the concrete structure. In addition, this technology can realize additive construction of suspended structures, allowing for construction in open spaces (such as the moon) without the need for templates. Furthermore, this technology has no weak interlayer bonding interface which exists in the 3D printed concrete technology, improving the strength and toughness of concrete structures.

Optionally, the step of analyzing the architecture parameters to obtain filament segment parameters, pillar parameters, and concrete parameters specifically includes:
obtaining terrain conditions;
performing simulation based on the terrain conditions, the architecture parameters, and an architecture template in a preset template database to determine a simulation result;
defining the architecture template as a standard architecture template when the simulation result meets a preset level requirement, where the preset level requirement includes a safety level parameter, a thermal insulation level parameter, and a mechanical performance level parameter;
optimizing the standard architecture template to obtain an optimized architecture template, where an optimization process includes reducing a quantity of the filament segments while still meeting the preset level requirement; and
determining the filament segment parameters, the pillar parameters, and the concrete parameters based on the optimized architecture template.

With the above technical solution, a qualified architecture template is determined through simulation, and is optimized based on an actual environment so as to output the most suitable construction parameters, improving the rationality and safety of the output construction parameters.

Optionally, the step of controlling, based on the filament segment parameters, the robotic arm to extrude filaments between the pillar and a preset ground surface specifically includes:
retrieving a corresponding filament template in a preset material database based on the filament segment parameters;
decomposing the filament template to obtain suitable filament materials and a mixing ratio;
mixing the suitable filament materials according to the mixing ratio and printing a first main filament segment through the robotic arm, where two ends of the first main filament segment are connected to the pillar or the ground surface; and
mixing the suitable filament materials according to the mixing ratio and printing a first main filament segment through the robotic arm, where the first auxiliary filament segment includes one end connected to the pillar or the ground surface, and the other end connected to the first main filament segment or another first auxiliary filament segment; alternatively, two ends of the first auxiliary filament segment are connected to the first main filament segment or another first auxiliary filament segment; and the filament segments include the first main filament segment and the first auxiliary filament segment.

Optionally, the step of mixing the suitable filament materials according to the mixing ratio specifically includes:
obtaining locally available material categories;
matching the locally available material categories with the suitable filament materials to obtain a filament template with a largest number of the suitable filament materials, defining the filament template with the largest number of the suitable filament materials as a matching filament template, defining the suitable filament materials corresponding to the matching filament template as matching filament materials, and defining a mixing ratio corresponding to the matching filament template as a matching mixing ratio; and
mixing the matching filament materials according to the matching mixing ratio.

With the above technical solution, working personnel can use local materials as much as possible, without transporting materials from distant places. For example, if all materials are transported from the Earth to the moon, there will be significant transportation costs. Therefore, using local materials reduces the transportation costs.

Optionally, another step of controlling, based on the filament segment parameters, the robotic arm to extrude filaments between the pillar and a preset ground surface specifically includes:
retrieving a corresponding finished filament in a preset finished product database based on the filament segment parameters;
fixedly connecting two ends of the finished filament to the pillar and the ground surface respectively through the robotic arm to form a second main filament segment; and
fixedly connecting one end of the finished filament to the pillar or the ground surface through the robotic arm to form a second auxiliary filament segment, and connecting the other end of the finished filament to the second main filament segment or another second auxiliary filament segment; alternatively, connecting two ends of the second auxiliary filament segment to the second main filament segment and/or another second auxiliary filament segment; where the filament segments include the second main filament segment and the second auxiliary filament segment.

Optionally, one end of at least one of the filament segments is connected to the ground surface.

With the above technical solution, the filament segment is connected to the ground surface, such that the house is anchored to the ground surface, preventing the displacement of the house caused by certain factors such as the low gravity environment of the moon, and improving the structural strength of the house.

Optionally, after the step of forming the filament segments and before the step of pouring concrete, the method further includes the following steps:
determining a pre-stretching path based on the filament segment parameters; and
controlling the robotic arm to pre-stretch the filament segments according to the pre-stretching path.

With the above technical solution, the filaments are pre-stretched, such that the filaments straighten due to the presence of prestress, thereby improving the overall strength and quality of the concrete structure.

Optionally, after the step of forming the cocoon-like shell and before the step of forming the architectural shell, the method further includes the following steps:
after the cocoon-like shell is formed, controlling the robotic arm to extend into the cocoon-like shell and perform milling and polishing;
disposing a thermal and sound insulation layer on an inner surface of the cocoon-like shell; and
coloring the inner surface of the cocoon-like shell through a coating process.

With the above technical solution, the interior of the house is smooth and pleasing to the eye through the milling and polishing and coloring processes. Moreover, the thermal and sound insulation layers make the interior of the house less susceptible to external environmental interference.

Optionally, after the step of forming the architectural shell, the method further includes the following steps:
removing the telescopic rod, and cutting off the first main filament segment and the first auxiliary filament segment exposed outside the architectural shell.

With the above technical solution, the pillars are removed after the completion of the architecture to achieve recycling, thereby saving material costs.

In a second aspect, the present disclosure provides a bionic architecture construction system, which adopts the following technical solutions:

A bionic architecture construction system includes:
an obtaining module, configured obtain architecture parameters, terrain conditions, and locally available material categories;
a memory, configured to store a program of a control method for any of the above bionic architecture construction method; and
a processor, configured to load and execute the program in the memory, to implement the control method for any of the above bionic architecture construction method.

With the above technical solution, filaments are connected to form reinforcing ribs, and then concrete is poured onto the filaments, thereby completing the construction of an architecture and improving the strength and toughness of the concrete structure. In addition, this technical solution can realize additive construction of suspended structures, allowing for construction in open spaces (such as the moon) without the need for templates. Furthermore, this technical solution has no weak interlayer bonding interface which exists in the 3D printed concrete technology, improving the strength and toughness of concrete structures.

To sum up, the present disclosure has at least beneficial effects below:
1. Filaments are connected to form reinforcing ribs, and then concrete is poured onto the filaments, thereby completing the construction of an architecture and improving the strength and toughness of the concrete structure;
2. Filaments are connected to form reinforcing ribs, and then concrete is poured onto the filaments, thereby completing the construction of an architecture, and realizing additive construction of suspended structures, allowing for construction in open spaces (such as the moon) without the need for templates;
3. Filaments are connected to form reinforcing ribs, and then concrete is poured onto the filaments, thereby completing the construction of an architecture. There is no weak interlayer bonding interface which exists in the 3D printed concrete technology, thus improving the strength and toughness of concrete structures; and
4. Working personnel can use local materials as much as possible, without transporting materials from distant places, thereby reducing the transportation costs.

### DESCRIPTION OF THE DRAWINGS

FIG. 1 is a flowchart of a bionic architecture construction method according to an embodiment of the present disclosure.

FIG. 2 is a schematic diagram of a bionic architecture construction process according to an embodiment of the present disclosure.

FIG. 3 is a flowchart of the specific step of analyzing the architecture parameters to obtain filament segment parameters, pillar parameters, and concrete parameters according to an embodiment of the present disclosure.

FIG. 4 is a flowchart of the specific step of controlling, based on the filament segment parameters, the robotic arm to extrude filaments between the pillar and a preset ground surface according to an embodiment of the present disclosure.

FIG. 5 is a flowchart of the specific step of mixing the suitable filament materials according to the mixing ratio according to an embodiment of the present disclosure.

FIG. 6 is a flowchart of another specific step of controlling, based on the filament segment parameters, the robotic arm to extrude filaments between the pillar and a preset ground surface according to an embodiment of the present disclosure.

FIG. 7 is a diagram of modules of a bionic architecture construction system according to an embodiment of the present disclosure.

### SPECIFIC IMPLEMENTATIONS

To make the objectives, technical solutions, and advantages of the present disclosure clearer, the present disclosure is further described in detail below with reference to the accompanying drawings 1 to 7 and embodiments. It should be understood that the examples described herein are merely used to explain the present disclosure, rather than to limit the present application.

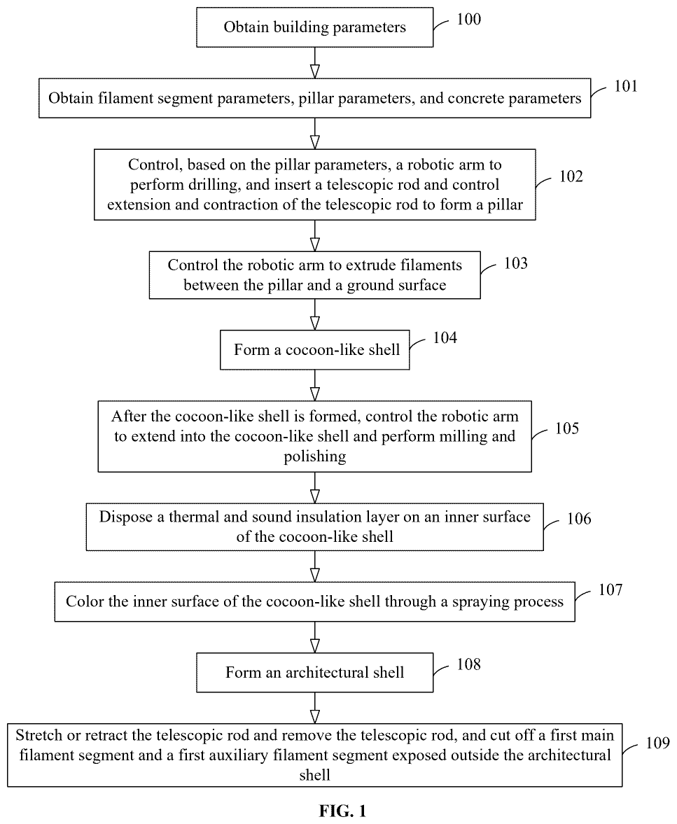

An embodiment of the present disclosure provides a bionic architecture construction method. With reference to FIG. 1, a bionic architecture construction method includes:

Step 100: obtain architecture parameters.

The architecture parameters refer to parameters of an architecture that needs to be constructed, including the functional requirements of the base architecture, the combination of positions of functional components (beds/bathrooms/kitchens/workspaces/sports rooms, etc.) inside the architecture, the architecture area, and the priority of the functional requirements, and the layout design of the functional components inside the architecture. The architecture parameters can be obtained by manually input.

Step 101: analyze the architecture parameters to obtain filament segment parameters, pillar parameters, and concrete parameters.

The filament segment parameters include the quantity, size, thickness, pre-tension, layout, path planning, and other parameters of filament segments. The pillar parameters include the quantity, position, depth, height, and installation method of pillars. The concrete parameters include the thickness, material, pouring method, and curing method of the concrete.

Referring to FIG. 3, this step specifically includes the following steps:

Step 1011: obtain terrain conditions.

The terrain conditions refer to the conditions at the construction site, stratigraphic information, etc. The terrain conditions can be obtained by ground penetrating radar. The purpose is to determine a solid location for pile driving to facilitate construction.

Step 1012: perform simulation based on the terrain conditions, the architecture parameters, and an architecture template in a preset template database to determine a simulation result.

The architecture template is a template that has already been established in the simulation software. The template database is a database that stores architecture templates. The simulation result is a result of corresponding levels set in requirements such as safety parameters, seismic grade, and mechanical performance. The simulation result is determined by entering the terrain conditions and architecture parameters in simulation software. The architecture template can also be omitted, and an architecture model can be designed manually based on the terrain conditions and architecture parameters on site.

Step 1013: define the architecture template as a standard architecture template when the simulation result meets a preset level requirement.

The preset level requirement is the requirement for a required level and includes a safety level parameter, a thermal insulation level parameter, and a mechanical performance level parameter. Due to the fact that this method can be applied anywhere, even to lunar bases with harsh environments, the range of level requirement can be very large.

Step 1014: optimize the standard architecture template to obtain an optimized architecture template.

The optimized architecture template is an architecture template subjected to optimization. An optimization process includes reducing a quantity of the filament segments while still meeting the preset level requirement. This can improve construction speed while ensuring compliance with the preset level requirement.

Step 1015: determine the filament segment parameters, the pillar parameters, and the concrete parameters based on the optimized architecture template.

The determining method is to directly read the optimized architecture template, which also includes these parameters.

Referring to FIG. 1, step 102: control, based on the pillar parameters, a robotic arm to perform drilling, and insert a preset telescopic rod and control extension and contraction of the telescopic rod to form a pillar.

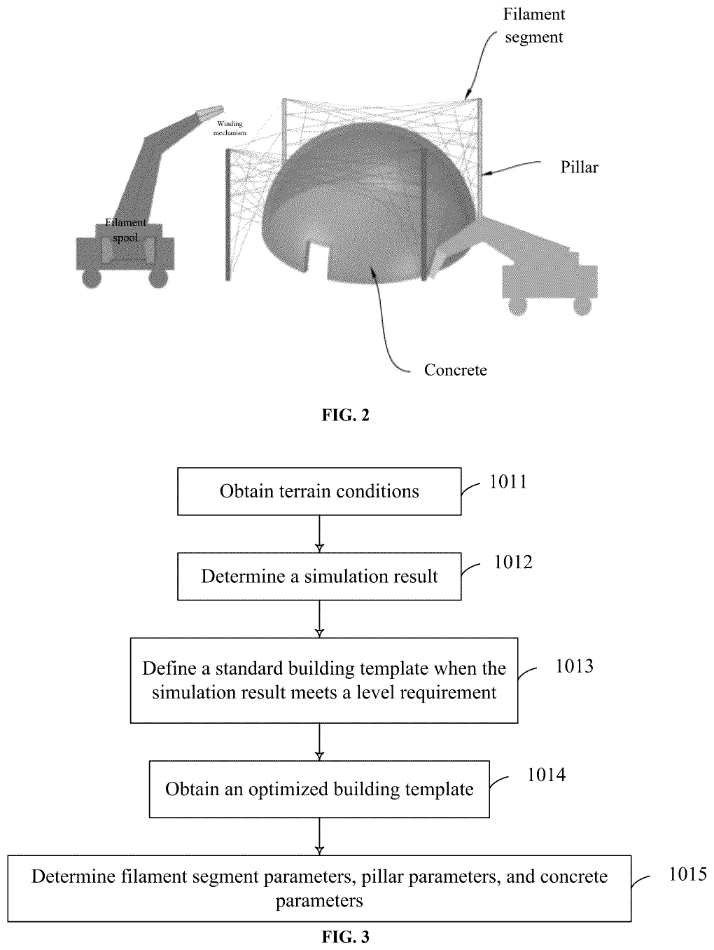

As shown in FIG. 2, the robotic arm is controlled to drill holes around a designated architecture, and columns are inserted into corresponding holes, thereby forming the pillars. For the convenience of controlling the height of the pillar, a telescopic rod can be used as the pillar. After the telescopic rod is inserted, anchor grout will also be filled to make the pillar stable and structurally strong.

step 103: control, based on the filament segment parameters, the robotic arm to extrude filaments between the pillar and a preset ground surface so as to form filament segments.

The filament segments are cooperatively arranged to form a cocoon-like skeleton.

Referring to FIG. 4, this step specifically includes the following steps:

Step 1031: retrieve a corresponding filament template in a preset material database based on the filament segment parameters.

The filament template is a template for a material type and mixing ratio of filaments. According to different situations, multiple materials are fused and combined to form filament segments with different characteristics, such as filament segments of different thicknesses, tensions, temperature shrinkage ratios, and stress-strain curves.

Step 1032: decompose the filament template to obtain suitable filament materials and a mixing ratio.

The suitable filament materials are constituent materials of filament segments that meet the required characteristics. The mixing ratio is a ratio that can meet the requirements of the filament template after the suitable filament materials are mixed.

Step 1033: mix the suitable filament materials according to the mixing ratio and print a first main filament segment through the robotic arm.

It should be noted that two ends of the first main filament segment are connected to the pillar or the ground surface, to serve as a main reinforcing rib.

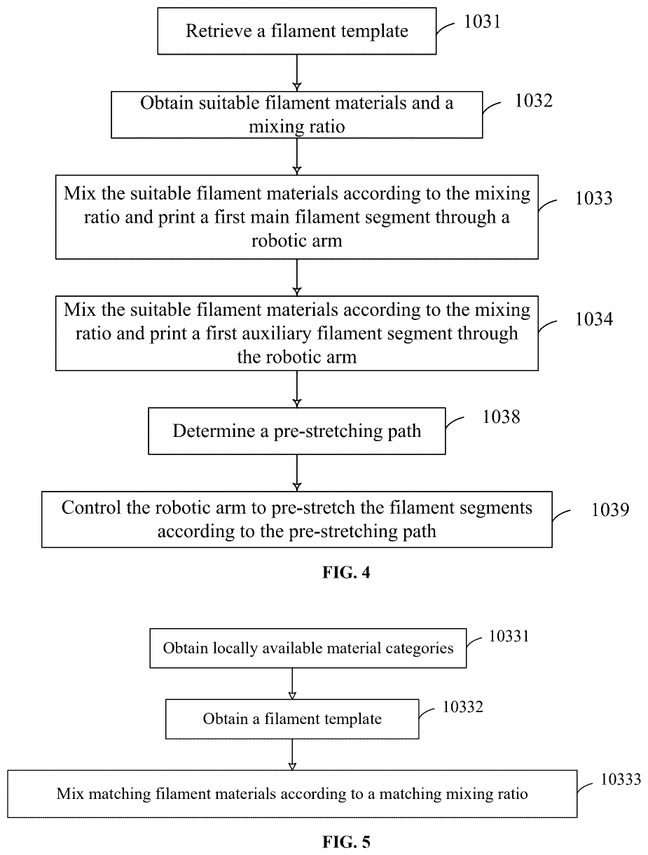

Referring to FIG. 5, the step of mixing the suitable filament materials according to the mixing ratio specifically includes:

Step 10331: obtain locally available material categories.

The locally available material categories refer to the categories of materials that can be obtained at the architecture location. The locally available material categories can be manually input.

Step 10332: match the locally available material categories with the suitable filament materials to obtain a filament template with a largest number of the suitable filament materials, define the filament template with the largest number of the suitable filament materials as a matching filament template, define the suitable filament materials corresponding to the matching filament template as matching filament materials, and define a mixing ratio corresponding to the matching filament template as a matching mixing ratio.

Step 10333: mix the matching filament materials according to the matching mixing ratio.

Finally, printing is performed according to the matching filament template to achieve maximum use of local materials.

Referring to FIG. 3, step 1034: mix the suitable filament materials according to the mixing ratio and print a first auxiliary filament segment through the robotic arm.

The first auxiliary filament segment includes one end connected to the pillar or the ground surface, and the other end connected to the first main filament segment or another first auxiliary filament segment. Alternatively, two ends of the first auxiliary filament segment are connected to the first main filament segment or another first auxiliary filament segment. The filament segments include the first main filament segment and the first auxiliary filament segment. One end of at least one of the filament segments is connected to the ground surface, such that the house is anchored to the ground surface, preventing the displacement of the house caused by the low gravity environment of the moon. The anchoring device can be made of high-strength materials such as steel or synthetic fiber products.

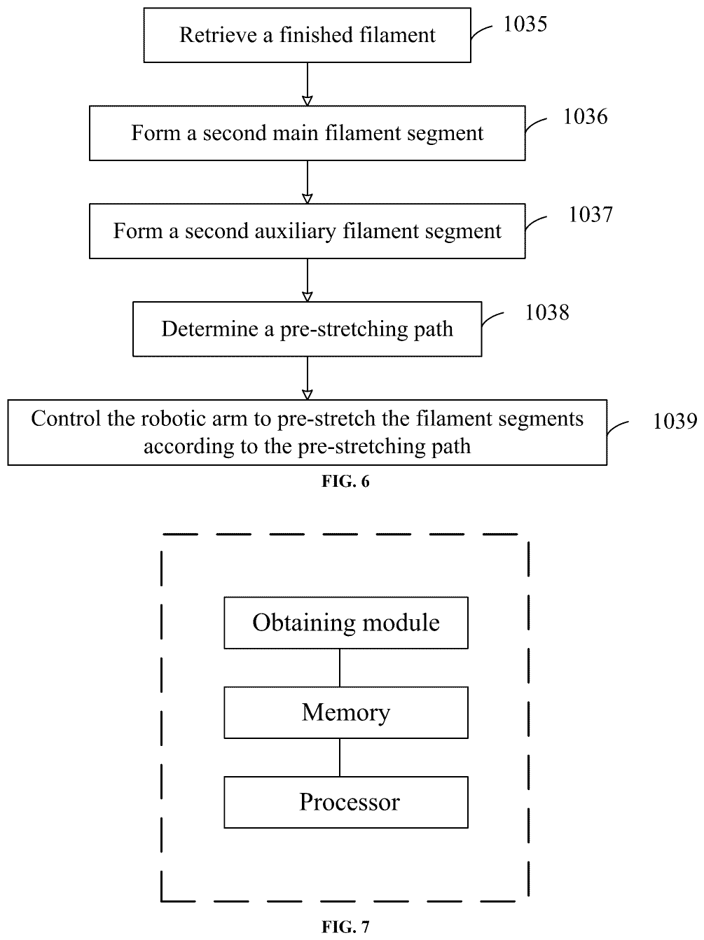

Referring to FIG. 6, in another embodiment, another specific step of controlling, based on the filament segment parameters, the robotic arm to extrude filaments between the pillar and a preset ground surface specifically includes:

Step 1035: retrieve a corresponding finished filament in a preset finished product database based on the filament segment parameters.

The finished filament refers to a filament that has already been prepared and is composed of the filament segment parameters. The database stores a mapping relationship between finished filaments and the filament segment parameters. The database is artificially established. When a system receives the filament segment parameters, the system automatically checks whether there is a corresponding finished filament, and if so, outputs it. By using the finished filament, a length of the filament can be precisely controlled and the filament can be bonded and fixed to the corresponding design position.

Step 1036: fixedly connect two ends of the finished filament to the pillar and the ground surface respectively through the robotic arm to form a second main filament segment.

As shown in FIG. 2, there is already a filament spool in a construction car, the filament can be wound between two pillars through a winding mechanism, and two ends of the filament are fixed by adhesive, welding, binding, and other methods.

Step 1037: fixedly connect one end of the finished filament to the pillar or the ground surface through the robotic arm to form a second auxiliary filament segment.

The other end of the finished filament is connected to the second main filament segment or another second auxiliary filament segment. Alternatively, two ends of the second auxiliary filament segment are connected to the second main filament segment and/or another second auxiliary filament segment. The filament segments include the second main filament segment and the second auxiliary filament segment. One end of at least one of the filament segments is connected to the ground surface.

Step 1038: determine a pre-stretching path based on the filament segment parameters.

The pre-stretching path refers to a path along which the robotic arm straightens the filament and pre-stress is generated. A determined method can be a searching method.

Step 1039: control the robotic arm to pre-stretch the filament segments according to the pre-stretching path.

Due to the possibility that the newly installed filament segment may not be straight and there is no pre-stress, in order to enhance the structural strength of the reinforcing ribs, the filament segment is pre-stretched. Steps 1038 and 1039 need to be carried out after two different steps of controlling, based on the filament segment parameters, the robotic arm to extrude filaments between the pillar and the preset ground surface. Regardless of which one is used, the filament segment must be pre-stretched to improve structural strength.

Referring to FIG. 1, step 104: pour concrete into the cocoon-like skeleton based on the concrete parameters to form a cocoon-like shell.

The cocoon-like shell is a closed structure with the filament segments embedded within the concrete. The pouring methods may be as follows: 1. Concrete can be poured with a nozzle on the inner surface of the cocoon-like skeleton, tightly adhering to the inner surface for extrusion. Cement passes through the filament segments and aggregates on the cocoon-like skeleton, forming a concrete whole containing filament segments inside, thus forming the cocoon-like shell; 2. Solid materials (such as aggregates) are first stacked on the cocoon-like skeleton, and then liquid materials (such as cement paste) are poured to form a concrete layer through solid-liquid reaction; 3. A robotic arm is directly used to mount a concrete deployment head for the deployment of concrete materials, due to the low fluidity of concrete, a concrete layer of certain thickness will be formed on the cocoon-like skeleton; 4. Solid materials are stacked on the cocoon-like skeleton, followed by solidification using laser melting, to form a structural layer that meets mechanical properties. Materials such as poured concrete (ultra-high performance concrete (UHPC)) can be selected. After the concrete is wrapped around the cocoon-like skeleton, vibration is performed to make the concrete itself denser and bond more tightly with the skeleton, preventing the occurrence of voids.

After concreting, the pre-stressed concrete is maintained to ensure its strength and durability. The maintenance method can be selected and adjusted according to the special environment of the moon.

Step 105: after the cocoon-like shell is formed, control the robotic arm to extend into the cocoon-like shell and perform milling and polishing.

Only through extrusion and other operations, it is easy to produce unevenness, so milling and polishing are needed. The polishing tool can be a high-speed milling cutter.

Step 106: dispose a thermal and sound insulation layer on an inner surface of the cocoon-like shell.

The thermal and sound insulation layer is a layer that isolates heat and noise. In order to improve the heat insulation and sound insulation effect of cocoon type architectures, heat and sound insulation materials such as foam concrete and rock wool can be applied inside the architecture. These materials can effectively reduce heat loss and noise interference inside the architecture.

Step 107: color the inner surface of the cocoon-like shell through a coating process.

The purpose of coloring is for aesthetics.

Step 108: control, based on the architecture parameters, the robotic arm to form a window and a door on the cocoon-like shell to form an architectural shell.

The architectural shell is the basic external shell structure of an architecture.

Step 109: remove the telescopic rod, and cut off the first main filament segment and the first auxiliary filament segment exposed outside the architectural shell.

After the house structure solidifies and stabilizes, the pillars can be removed, and the telescopic rods can be collected and reused. For the sake of aesthetics, the first main filament segment and the first auxiliary filament segment exposed outside the architectural shell are cut off.

Based on the same inventive concept, an embodiment of the present disclosure provides a bionic architecture construction system.

With reference to FIG. 7, a bionic architecture construction system includes:
an obtaining module, configured obtain architecture parameters, terrain conditions, and locally available material categories;
a memory, configured to store a program of a control method for a bionic architecture construction method; and
a processor, configured to load and execute the program in the memory, to implement a control method for a bionic architecture construction method.

Those skilled in the art can clearly understand that, for convenience and conciseness of description, only the division of the foregoing function modules is used as an example. In practical applications, the foregoing functions may be allocated to and completed by different function modules as required, that is, an internal structure of the apparatus is divided into different function modules to complete all or some of the functions described above. For a specific working process of the system, apparatus, and unit described above, refer to the corresponding process in the foregoing method embodiments. Details are not described herein again.

The above described are preferred examples of this application, but the protection scope of this application is not limited thereto. Any feature disclosed in this specification (including abstract and drawings), unless specifically stated, may be replaced by other alternative features with equivalent or similar purposes. That is, unless specifically stated, each feature is just one example of a series of equivalent or similar features.

What is claimed is:

1-10. (canceled)

11. A bionic architecture construction method, comprising:
obtaining architecture parameters;
analyzing the architecture parameters to obtain filament segment parameters, pillar parameters, and concrete parameters;
controlling, based on the pillar parameters, a robotic arm to perform drilling, and inserting a preset telescopic rod and controlling extension and contraction of the telescopic rod to form a pillar;
controlling, based on the filament segment parameters, the robotic arm to extrude filaments between the pillar and a preset ground surface so as to form filament segments, wherein the filament segments are cooperatively arranged to form a cocoon-like skeleton;
pouring concrete into the cocoon-like skeleton based on the concrete parameters to form a cocoon-like shell, wherein the cocoon-like shell is a closed structure with the filament segments embedded within the concrete; and
controlling, based on the architecture parameters, the robotic arm to form a window and a door on the cocoon-like shell to form an architectural shell;
wherein the step of controlling, based on the filament segment parameters, the robotic arm to extrude the filaments between the pillar and the preset ground surface comprises:
retrieving a corresponding filament template in a preset material database based on the filament segment parameters;
decomposing the filament template to obtain suitable filament materials and a mixing ratio;
mixing the suitable filament materials according to the mixing ratio and printing a first main filament segment through the robotic arm, wherein two ends of the first main filament segment are connected to the pillar or the ground surface; and
mixing the suitable filament materials according to the mixing ratio and printing a first auxiliary filament segment through the robotic arm, wherein the first auxiliary filament segment comprises a first end connected to the pillar or the ground surface, and a second end connected to the first main filament segment or another first auxiliary filament segment;
alternatively, two ends of the first auxiliary filament segment are connected to the first main filament segment or another first auxiliary filament segment; and the filament segments comprises the first main filament segment and the first auxiliary filament segment.

12. The bionic architecture construction method according to claim 11, wherein the step of analyzing the architecture parameters to obtain the filament segment parameters, the pillar parameters, and the concrete parameters comprises:
obtaining terrain conditions;
performing simulation based on the terrain conditions, the architecture parameters, and an architecture template in a preset template database to determine a simulation result;
defining the architecture template as a standard architecture template when the simulation result meets a preset level requirement, wherein the preset level requirement comprises a safety level parameter, a thermal insulation level parameter, and a mechanical performance level parameter;
optimizing the standard architecture template to obtain an optimized architecture template, wherein an optimization process comprises reducing a quantity of the filament segments while still meeting the preset level requirement; and
determining the filament segment parameters, the pillar parameters, and the concrete parameters based on the optimized architecture template.

13. The bionic architecture construction method according to claim 11, wherein the step of mixing the suitable filament materials according to the mixing ratio comprises:
obtaining locally available material categories;
matching the locally available material categories with the suitable filament materials to obtain a filament template with a largest number of the suitable filament materials, defining the filament template with the largest number of the suitable filament materials as a matching filament template, defining the suitable filament materials corresponding to the matching filament template as matching filament materials, and defining a mixing ratio corresponding to the matching filament template as a matching mixing ratio; and
mixing the matching filament materials according to the matching mixing ratio.

14. The bionic architecture construction method according to claim 11, wherein the step of controlling, based on the filament segment parameters, the robotic arm to extrude the filaments between the pillar and the preset ground surface comprises:
retrieving a corresponding finished filament in a preset finished product database based on the filament segment parameters;
fixedly connecting two ends of the finished filament to the pillar and the ground surface respectively through the robotic arm to form a second main filament segment; and
fixedly connecting a first end of the finished filament to the pillar or the ground surface through the robotic arm to form a second auxiliary filament segment, and connecting a second end of the finished filament to the second main filament segment or another second auxiliary filament segment; alternatively, connecting two ends of the second auxiliary filament segment to the second main filament segment and/or another second auxiliary filament segment; wherein the filament segments comprise the second main filament segment and the second auxiliary filament segment.

15. The bionic architecture construction method according to claim 11, wherein an end of at least one of the filament segments is connected to the ground surface.

16. The bionic architecture construction method according to claim 11, wherein after the step of forming the filament segments and before the step of pouring the concrete, the bionic architecture construction method further comprises the following steps:
determining a pre-stretching path based on the filament segment parameters; and
controlling the robotic arm to pre-stretch the filament segments according to the pre-stretching path.

17. The bionic architecture construction method according to claim 11, wherein after the step of forming the cocoon-like shell and before the step of forming the architectural shell, the bionic architecture construction method further comprises the following steps:
after the cocoon-like shell is formed, controlling the robotic arm to extend into the cocoon-like shell and perform milling and polishing;
disposing a thermal and sound insulation layer on an inner surface of the cocoon-like shell; and
coloring the inner surface of the cocoon-like shell through a coating process.

18. The bionic architecture construction method according to claim 11, wherein after the step of forming the architectural shell, the bionic architecture construction method further comprises the following steps:
removing the telescopic rod, and cutting off the first main filament segment and the first auxiliary filament segment exposed outside the architectural shell.

19. A bionic architecture construction system, comprising:
an obtaining module, configured obtain architecture parameters, terrain conditions, and locally available material categories;
a memory, configured to store a program of a control method for the bionic architecture construction method according to claim 11; and
a processor, configured to load and execute the program in the memory, to implement the control method for the bionic architecture construction method according to claim 11.

20. The bionic architecture construction method according to claim 14, wherein an end of at least one of the filament segments is connected to the ground surface.

21. The bionic architecture construction method according to claim 14, wherein after the step of forming the filament segments and before the step of pouring the concrete, the bionic architecture construction method further comprises the following steps:
determining a pre-stretching path based on the filament segment parameters; and
controlling the robotic arm to pre-stretch the filament segments according to the pre-stretching path.

22. The bionic architecture construction system according to claim 19, wherein in the bionic architecture construction method, the step of analyzing the architecture parameters to obtain the filament segment parameters, the pillar parameters, and the concrete parameters comprises:
obtaining terrain conditions;
performing simulation based on the terrain conditions, the architecture parameters, and an architecture template in a preset template database to determine a simulation result;
defining the architecture template as a standard architecture template when the simulation result meets a preset level requirement, wherein the preset level requirement comprises a safety level parameter, a thermal insulation level parameter, and a mechanical performance level parameter;
optimizing the standard architecture template to obtain an optimized architecture template, wherein an optimization process comprises reducing a quantity of the filament segments while still meeting the preset level requirement; and
determining the filament segment parameters, the pillar parameters, and the concrete parameters based on the optimized architecture template.

23. The bionic architecture construction system according to claim 19, wherein in the bionic architecture construction method, the step of mixing the suitable filament materials according to the mixing ratio comprises:
obtaining locally available material categories;
matching the locally available material categories with the suitable filament materials to obtain a filament template with a largest number of the suitable filament materials, defining the filament template with the largest number of the suitable filament materials as a matching filament template, defining the suitable filament materials corresponding to the matching filament template as matching filament materials, and defining a mixing ratio corresponding to the matching filament template as a matching mixing ratio; and
mixing the matching filament materials according to the matching mixing ratio.

24. The bionic architecture construction system according to claim 19, wherein in the bionic architecture construction method, the step of controlling, based on the filament segment parameters, the robotic arm to extrude the filaments between the pillar and the preset ground surface comprises:
retrieving a corresponding finished filament in a preset finished product database based on the filament segment parameters;
fixedly connecting two ends of the finished filament to the pillar and the ground surface respectively through the robotic arm to form a second main filament segment; and
fixedly connecting a first end of the finished filament to the pillar or the ground surface through the robotic arm to form a second auxiliary filament segment, and connecting a second end of the finished filament to the second main filament segment or another second auxiliary filament segment; alternatively, connecting two ends of the second auxiliary filament segment to the second main filament segment and/or another second auxiliary filament segment; wherein the filament segments comprise the second main filament segment and the second auxiliary filament segment.

25. The bionic architecture construction system according to claim 19, wherein in the bionic architecture construction method, an end of at least one of the filament segments is connected to the ground surface.

26. The bionic architecture construction system according to claim 19, wherein after the step of forming the filament segments and before the step of pouring the concrete, the bionic architecture construction method further comprises the following steps:
determining a pre-stretching path based on the filament segment parameters; and
controlling the robotic arm to pre-stretch the filament segments according to the pre-stretching path.

27. The bionic architecture construction system according to claim 19, wherein after the step of forming the cocoon-like shell and before the step of forming the architectural shell, the bionic architecture construction method further comprises the following steps:
after the cocoon-like shell is formed, controlling the robotic arm to extend into the cocoon-like shell and perform milling and polishing;
disposing a thermal and sound insulation layer on an inner surface of the cocoon-like shell; and
coloring the inner surface of the cocoon-like shell through a coating process.

28. The bionic architecture construction system according to claim 19, wherein after the step of forming the architectural shell, the bionic architecture construction method further comprises the following steps:
removing the telescopic rod, and cutting off the first main filament segment and the first auxiliary filament segment exposed outside the architectural shell.
